(19) United States
(12) Patent Application Publication
(10) Pub. No.: US 2008/0270097 A1
(43) Pub. Date: Oct. 30, 2008

(54) System and methods for immunocomputing applied to collectives of nanorobots

(75) Inventor: Neal Solomon, Oakland, CA (US)

Correspondence Address: Neal Solomon, PO Box 21297, Oakland, CA, 94620, US

(73) Assignee: Solomon Research LLC, Oakland, CA (US)

(21) Appl. No.: 11/985,074

(22) Filed: Nov. 13, 2007

Related U.S. Application Data
(60) Provisional application No. 60/865,605, filed on Nov. 13, 2006.
(60) Provisional application No. 60/912,133, filed on Apr. 16, 2007.
(60) Provisional application No. 60/941,600, filed on Jun. 1, 2007.
(60) Provisional application No. 60/958,466, filed on Jul. 7, 2007.

(51) Int. Cl. G06G 7/60

(52) U.S. Cl. 703/11

(57) ABSTRACT

The invention describes immunocomputing methods for application to collectives of nanorobots (CNRs). The system provides a hybrid synthesis of adaptive immune system problem solving and anticipatory problem solving in the CNR environment. Modeling methods are advanced to guide the transformation process of CNRs in the context of evolvable hardware, including a time-series modeling approach.

### CROSS-REFERENCES TO RELATED APPLICATIONS

The present application claims the benefit of priority under 35 U.S.C. § 119 from U.S. Provisional Patent Application Ser. No. 60/865,605, filed on Nov. 13, 2006, U.S. Provisional Patent Application Ser. No. 60/912,133, filed Apr. 16, 2007, U.S. Provisional Patent Application Ser. No. 60/941,600, filed Jun. 1, 2007 and U.S. Provisional Patent Application No. 60/958,466, filed Jul. 7, 2007, the disclosures of which are hereby incorporated by reference in their entirety for all purposes.

### FIELD OF THE INVENTION

The present invention involves nanotechnology, nanoelectromechanical systems (NEMS) and microelectromechanical systems (MEMS). The invention also deals with collective robotics (CR) on the nano-scale, or collective nano-robotics (CNR) and nano-scale mechatronics control theory. The invention deals with bio-inspired computing systems, including immunocomputing. Applications of nano-evolvable hardware (N-EHW) include bio-medical and electronics apparatuses and techniques.

### BACKGROUND OF THE INVENTION

The field of collective robotics (CR) has a literature that involves organized systems of groups of robots for specific applications. These applications include factory automation, reconnaissance, remote sensing, traffic coordination, security and hazard management.

One way to organize CR systems is to develop a hybrid control system. In one example of a hybrid control system, central control is combined with elements of behavior-based control. In another example, a multi-agent system (MAS) is integrated with a multi-robotic system (MRS). These systems use elements of evolutionary computation in order for the system to autonomously compute the environmental feedback that must be overcome to achieve a goal.

CR systems are examples of advanced hardware systems that employ self-organizational capacities analogous to ones in nature. The bio-inspired computing literature has emerged to identify artificial methods to emulate, and surpass, specific naturally occurring biological systems. For example, the protein network that allows communication between living cells, the neural plasticity of the human brain or the adaptive operation of the human immune system are examples of biological system capabilities that are emulated by artificial systems in computer science.

Since 1996, researchers at MIT have developed the concept of “amorphous computing” which is applicable to nanorobotics collectives. Amorphous computing architectures involve large numbers of identical parallel computer processors that have local environmental interactions. This network computing architecture uses swarm intelligence algorithms (particle swarm optimization, ant colony optimization and stochastic diffusion search) to coordinate the behaviors of equivalent computational entities to achieve a goal. While amorphous computing borrows from grid computing models, it is limited to programmable, not reprogrammable, functions. Further, the model only uses identical computing devices, much like ants or bees in colonies or hives. Finally, the system only uses local control to interact with the nearest neighbors.

Researchers at the Institute for Robotics and Intelligent Systems at USC have developed a system for collective microrobots by organizing robots to cooperate using local rules by using computer simulations.

Since 2001, researchers at Carnegie Mellon University have developed a system for “synthetic reality” called “claytronics” which uses “programmable matter” to self-organize into different shapes. This novel system develops novel hardware and software to organize three dimensional shapes. Claytronics uses components called “catoms” (claytronic atoms) that adhere to each other and interact in three dimensions. The claytronics system combines ideas from amorphous computing and reconfigurable robotics. However, to date, the goal of organizing millions of micro-robotic entities has not been achieved.

Few researchers have devised solutions to these complex nano-scale problems. Cavalcanti has developed theoretical notions to develop a model of collective nanorobotics. However, these solutions are not practical and will not work in real situations. For example, there is not enough power of mobility in this model to overcome natural forces. Similarly, according to this theoretical approach, autonomous computation resources of nanorobots are insufficient to perform even the simplest functions, such as targeting. Without computation capacity, AI will not work at this level; without AI there is no possible way to perform real-time environmental reaction and interaction.

Cavalcanti's 2D and 3D simulations are dependent on only several variable assumptions and will not withstand the “chaos” of real environmental interactive processes. In addition, the structure of these nanorobots cannot be built efficiently from the bottom up and still retain critical functionality. Even if these many problems can be solved, individual nanorobots cannot be trusted to behave without error inside cells. In other words, this conceptual generation of medical nanorobots may do more harm than good, particularly if they are not controllable.

Solomon's research in developing hybrid control systems for collective robotics systems and in developing novel approaches for molecular modeling systems presents pathways to solving these complex problems. These original research streams are used in the present invention.

Prior systems of collective robotics generally do not address the complexities of nanotechnology. The behavior-based robot system using subsumption methods developed by Brooks at MIT is useful for managing individual robot behavior with limited computation capacity. On the other end of the spectrum, central control robotic systems require substantial computation resources. Hybrid control robotic systems synthesize elements from these two main control processes. Even more advanced robotic control systems involve the integration of a multi-agent software system with a robotic system that is particularly useful in controlling collectives of robots. This advanced collective robotic control system experiences both the benefits and detriments of the behavior-based model and the central control model.

Recent developments in collective robotics have borrowed inspiration from complex biological processes. Complex social behaviors such as flocking, herding and schooling have been studied, with ant algorithms representing the state of the art in computationally emulating and optimizing natural processes. Even more complex natural behaviors at the molecular level are discovered as we learn more about protein interactions. Specifically, the human immune system is a fascinating dynamic interactive network that has evolved over many years. Our challenge is to develop artificial mechanisms to surpass not only ant algorithms, which use the collective behavior of autonomous individuals that use chemical communications methods, but also the interactive workings of the human immunological system.

One of the main methods to develop these complex artificial network models for use in robotic systems is to use evolutionary computation, which emulates biological processes of evolution. Methods such as genetic algorithms or genetic programs emulate the behavior of generations of populations in order to solve complex problems. Similarly, artificial neural network approaches emulate the ability of the human brain to adapt to its environment in order to solve complex problems.

The development of cooperating collectives of robots in a network borrows inspiration from these biological systems. A team of interacting agents takes inspiration from the effective operation of a beehive or an ant colony in which specialist roles and coordination of tasks occur among thousands of agents. These complex network systems use self-organizing models of behavior to aggregate (combine into groups), to reaggregate and to adapt to their environment. However, there are limits to these models because of the constraints of communication, coordination, “computation” and adaptation. The development of artificial systems of collective robotics represents opportunities to surpass these limits. The present system offers numerous insights into optimizing these complex processes.

One of the most prominent recent examples of bio-inspired computing lies in the field of immunocomputing. Computer systems are organized to emulate the humoral and adaptive human immune system operations. In the case of the humoral immune system, a cascade of proteins is emulated in order to accomplish a specific task. In the case of the adaptive immune system, a novel pathogen will stimulate a reaction by specific antibodies which will attack the pathogen and learn to attack similar future pathogens. This process provides a learning and adaptive component that is useful in computational processes that deal with accomplishing goals in the context of feedback from uncertain and indeterministic environments.

In the development of collective robotics at the nano scale, however, there are distinctive features that distinguish the system from the macro scale. For example, collectives of nanorobots (CNR) have substantial resource constraints, including computation and communications resource limitations. In order for a CNR to exhibit self-organization capabilities, the system must demonstrate artificial intelligence for autonomous behaviors. Hence it is necessary to develop a novel system for efficient AI that optimizes computation hardware and software resources. This research stream is still evolving.

The field of evolvable hardware (EHW) is divided into two areas: electronics and robotics. In electronics, the main uses of EHW are in field programmable gate arrays (FPGAs). In robotics, EHW is applied to robots that transform their physical structure by adding or transforming parts. In the context of extending EHW to the nanoscale, there are numerous problems to overcome. Particularly in applications involving biology or medicine, the application of EHW to nanorobotics (N-EHW) presents a range of interesting challenges.

Problems that the Present System Solves

There are several classes of problem that the present system addresses. In some cases, combinatorial optimization problems require the identification of a complex arrangement of nanorobotic parts to be assembled and reassembled in a particular order. Another class of problems involves environmental interaction with a CNR system. In order to achieve a goal in an evolving environment, key constraints must be satisfied that require identifying environmental change.

These complex problems are grouped as multi-objective optimization problems (MOOPs) in which there are multiple choices between competing goals. Some of these MOOPs will take the form of temporal sequences in which the solution requires solving a succession of micro goals. The realization of specific thresholds in a process is necessary prior to pursuing the next goal in the sequence. Such contingent phases in a process are required in order for the CNR system to interact at each stage of environmental feedback.

In order to solve critical problems at the molecular biology scale, methods need to be delineated in which CNRs will aggregate together to form specific evolvable structures.

The present system focuses on applications in the biological and medical domains. In the biological domain, one problem involves producing CNR teams that aggregate into particular geometric architectures to emulate the functioning of proteins. It is necessary to find ways to identify, mask and precisely copy proteins in order to imitate their structure and behaviors. Specifically, it is necessary to find ways to use the CNRs in order to activate or deactivate particular genes by using the facsimile proteins as keys to induce a set of behaviors. In addition, the present system will use CNRs that are organized to emulate proteins in order to block gene functioning as well as to block enzymes from functioning.

Finally, it is necessary to find a way to identify CNR locations and activities along a series of pathways of trajectories. This method allows the coordination and integration of a collective of nanorobots as they solve problems.

### SUMMARY OF THE INVENTION

The present system emulates aspects of the human immune system. The self-organizing aspects of the human immune system contains both the humoral immune system in which a cascade of proteins attacks known pathogens, and the adaptive immune system in which antibodies encounter new pathogens, innovate and destroy the new pathogen. By using this process of passing known solutions of new pathogens to the humoral immune system, the system learns in order to attack the same pathogen more rapidly when next encountered.

The present system, however, introduces two additional immunocomputing systems: the artificial anticipatory immune system and the hybrid synthetic immune system. The combination of the several immunocomputing systems provides a powerful guide to the CNR system as it interacts with an evolving environment.

The system uses complex modeling techniques that involve combinatorial optimization. Specifically, the invention uses active geometrical combinatorial optimization solutions which involve solving multi-objective optimization problems (MOOPs). The system uses models to delimit the initial search space to identify possible parameters of solutions over time. The models then filter out what is clearly not possible in order to delimit probable parameters. The models filter specific sets of options, excluding some categories of sets, thereby leaving other sets that result from the overlap of specific inclusive criteria. The convergence of sets at geometrical points extensible in space—or overlapping sets—is then identified as the optimal range of a specific problem. CNRs will then configure into this range and refine the process until they have achieved an optimal aggregation configuration.

There are different types of combinatorial optimization problems involving CNRs. In general, these solutions involve solving MOOPs for multiple criteria such as functional robotic effectiveness, efficient robotic collective combination design, removal of 3-D object constraints, trajectory pathway and velocity organization and synchronization of the CNR system. The most prominent class of geometric optimization problems involves identifying the optimal extensible robotic configuration within environmental constraints.

The addition of indeterministic evolutionary environmental change to the models adds a layer of complexity to these problems. Designing complex systems that interact in evolutionary processes requires addressing another class of combinatorial optimization problems involving temporal features that are solved by the present invention. The models actively conduct a process of seeking solutions to problems that involve evolving temporal characteristics. The shifting of geometric spatial options occurs over time that requires constant recalibration of optimal configurations. The robotic collective configurations are constantly changing, which require multiple combinatorial optimization solutions.

Immunocomputing processes described herein are applied to microrobotic collectives as well as to nanorobotic collectives to solve problems.

### Advantages of the Present Invention

In addition to creating a novel way to develop evolvable hardware (EHW) that is applied to nano-scale apparatuses, the system improves on the natural immune system by developing a modeling process that learns. This anticipatory AIS system is useful in providing interactive solutions to evolutionary collective robotics problems, particularly at the cellular level.

### DESCRIPTION OF THE INVENTION

### (I) Immunocomputing Applied to CNRs

The biologically inspired computing literature has focused on developing ways to emulate the human immune system. Specifically, there are two main immune systems. First, the humoral immune system produces a cascade of proteins in order to invade a known pathogen after it has been detected. Second, the adaptive immune system identifies hitherto unknown pathogens and develops mechanisms to rapidly attack the pathogens and remember (i.e., learn) the specific genetic code of the pathogens for further identification.

While the present system will integrate aspects of these two bio-inspired computing mechanisms into the CNR system, it adds two additional analytical immune system feedback and response mechanisms that are applied to the autonomous and self-organizing behaviors of nanorobotic collectives.

The first original immunocomputing mechanism disclosed in the present system is anticipatory. Anticipatory immunocomputing uses models that plot the trajectories of the development of potential pathogens and prepare the system for these before they occur in order to develop a very rapid response.

The second model presented here involves a hybrid synthesis of the three prior immunocomputing models. In this model, the three subsystem immunocomputing models work together. For example, though the anticipatory model builds on the adaptive model, both of these models use mechanisms of the humoral immune system's cascade effects to request antibody reinforcements to complete a task efficiently. Similarly, the adaptive model will “learn” aspects about novel pathogens that are used by the anticipatory model in order to develop more accurate forecasts and predictions from simulations, such as ones involving the rate of change of a antigen's mutations that affect its growth trajectory. The combination of these immunocomputing models better prepare the CNR system to defend itself from invasions and to complete tasks more effectively.

### (1) Anticipatory Immunocomputing Applied to CNR System

Anticipatory immunocomputing uses models to simulate the trajectories of self-organizing behaviors. The models used by the system contain data inputs from the CNR system and are analyzed to assess the trajectories of environmental conditions. The environmental objects are simulated over time in order to develop forecasts and predictions of their behaviors. The system projects probable environmental behaviors within specific ranges of likelihood.

Specifically, possible antigens are tracked and their mutations identified and compared in a time-series. Calculations of the rate of change of the mutations allow the model to plot the antigens' trajectories over time. This evidence of past evolutionary processes is then projected into the future in the form of scenarios based on the relative likelihood of occurrence in specific time frames.

This anticipatory immunocomputing model is useful for detecting potential problems in a complex dynamic system. Rather than wait for an unexpected event to occur and then react to it, the present system provides a higher level of preparation than prior immunocomputing models that were based on the humoral or adaptive human immune systems alone. Specifically, the present invention's use of anticipatory mechanisms allows the CNR system to respond to an attack far more rapidly, effectively and efficiently than any other approach because it brings precisely the right amount of defenses to tackle a particular problem at a particular time.

### (2) Hybrid Synthesis of Immunocomputing Models Applied to CNR System

Processes of the three main immunocomputing models are combined into a hybrid synthetic mechanism in the present invention. While the anticipatory immune system presented here is useful for modeling possible threats to the CNR system, and the adaptive immune system is useful for learning from prior events, both of these models will call upon the humoral immune system in order to summon the reserves of antibodies that do the actual attacking of the antigens. The anticipatory immune system is highly analytical and focuses on obtaining and analyzing data sets in order to perform its modeling so that it may present simulations about potential future scenario behaviors. The adaptive immune system is an intermediate approach that develops models based on limited current and past-based information about existing antigens that is analyzed in real time. The novel antigens are then integrated into specific antibodies to be used for detection of similar antigens.

Because the successive phases of the cascade effect of numerous proteins (antibodies) working together to defeat a known antigen are able to learn from prior phases, the humoral immune system processes are optimized. As the later phases of the successive groups of antibodies obtain information on the progress of the events, the newest information is passed on to the later phases in order to allow the succeeding phases to perfect the process by adapting to the threat.

In particular, the CNR teams learn from prior events and the feedback obtained from the process of interacting with the environment. The CNR teams will then request a next phase of N-EHW, or adapted, CNRs in order to accomplish a task.

By designing a system that combines all three immunocomputing models—the humoral, the adaptive and the anticipatory—the present system provides a powerful suite of approaches that will defeat attacks and solve complex problems. Specifically, the three immunocomputing subsystems work together to simultaneously attack prior antigens, analyze and attack novel antigens (which are then remembered for future attack by the adaptive function so the humoral immune system's cascade effects will be activated when the pathogen is encountered) and anticipate potential antigens, thus providing long-term insurance against powerful and destructive unknowable antigens.

All three main immunocomputing models share learning mechanisms to develop a hybrid model that combines the strengths of all the models.

The adaptive and learning aspects of the hybrid synthetic model for immunocomputing are then applied to complex problems such as identification of a specific protein and production of a mask that emulates the protein, so that the protein may be copied in real time in order to solve an intracellular problem.

Only the present hybrid model will solve complex evolving problems that require evolutionary solutions.

### (II) Modeling N-EHW

Modeling is used by the CNR system to assess its environment, anticipate the trajectory of various scenarios and plan strategies for achieving specific goals.

### (1) Modeling N-EHW to Guide Transformation Processes

Models are developed by the CNRs to organize behaviors of interaction with the environment. There are two main models: (1) the model of the CNR team and (2) the model of the environment. For the CNR team the model is deterministic because the CNRs can be controlled. But in the case of modeling the environment, the model is indeterministic because of uncertainties about future patterns of behavior. In modeling the evolving environment, inference methods are used to analyze data about the past. Analytical approaches that involve evolutionary computation techniques are used to develop simulation scenarios about potential future events, including forecasts and predictions of specific behaviors.

The environmental simulations are integrated into the main model to inform the strategic planning of the CNR team. The model of the CNRs is then used to recommend specific N-EHW configurations and transformations that are used to accomplish specific goals in the environment. The models of the CNR team and the environment are then reassessed and updated in order to recommend new N-EHW configurations and transformations. In most cases, the range of predictions made by the model about the environment is narrow, thereby requiring minimal changes in the hardware configurations of the CNR team. In volatile environments, however, the model shows a broader range of external environmental prediction expectation, which have reduced likelihood of accurate prediction. These environments create models that require greater N-EHW transformation to solve problems.

The models use cellular automata (CA) in order to track the progression of CNR performance. The CA modeling tracks specific nanorobots at one level, and CNR teams, on another level. This approach resembles a radar readout mechanism in which the trajectories of specific objects are tracked in time and space.

Use of the present modeling process also enables a view of the embryonic development and training mechanisms of the N-EHW as it obtains feedback from, and adapts to, the evolving environment. The model then learns from past experiments with interactions between the CNRs and the environment and integrates these experiences into the updated versions of the model. These later versions that include enhancements from learning are then used to provide strategic plans for actual CNR performance.

On one level, the modeling system usefully provides interaction mechanisms for the CNR system. This process in effect emulates the ethological behaviors of animals as they interact with the environment, but possesses critical enhancements to transcend the limitations of experience by including anticipatory capabilities that advanced modeling processes enable.

(2) External Computation for Modeling and Control of Collectives of Nanorobots with Periodicity Cycles

By using external computation resources, the CNRs have access to far more computation capacity than internal mechanisms allow. These supplemental computer resources are essential for solving CNR problems with collective resource constraints. There are several advantages of using external computer resources. First, the additional resources allow the processing of more data in real time. Second, the use of sophisticated databases dramatically expands computational analysis capacity. Third, complex software agents used in these external computers expediently solve problems. Finally, the use of modeling by external computers is key to problem solving for CNRs.

In order to operate in a connected system, nanorobots from the CNR obtain data from its nanorobotic sensors and supply the information to an external computer through a communication interface. The nanorobots may provide the information directly to the communication interface, route the data through leader nanorobots or route data through any nanorobotic node. In any event, the nanorobots may use communication repeaters to amplify or extend the signals to reach the communication interface. This sensor information, which includes real time location data on each mobile nanorobot, is then transmitted to the external computer.

From these data sets, complex models are developed by the external computer. These models are then used to evaluate scenarios and strategies in order to make decisions about continuously updatable behaviors and goals. Because of its greater resources, the external computer is able to guide the control of behaviors by analyzing the data and developing models.

This external computer system is similar to that used by NASA to control and analyze data from remote astronomical robotic vehicles. In both this case and the CNR case, significant communication lags sometimes occur because of the intermittency of communications capabilities. Consequently, the present system uses specific periodicity cycles of inputs from and outputs to the CNRs from the external computer. If at all possible, the external computer system anticipates CNR operations during these lag periods and will map out various simulation scenarios based on the statistical probabilities of achieving goals based on data and analysis from its prior experiences. The newest data from the experiences of the CNRs will then be input into the external computer's database.

During those times when the main CNR communication interface is inoperable, the external computer will attempt to contact specific nanorobots directly. This backup system is one of the redundancies that the system uses to increase the likelihood of success.

Since the CNR network itself develops computation analyses of the system's operation, the CNR computer system works in concert with the external computer and its modeling functions. The two main systems exchange data sets, continually update sensor data, share modeling scenarios and negotiate decisions for specific behaviors and tasks in real time. Data sets are automatically backed up to the off-site computer facility for storage. This intermittent access to data from CNRs provides a universal registry of events. These data sets are then analyzed for future CNR behavior control. Use of these external computer resources amplifies the utility of the present system.

This unique interoperability of the two systems promotes the view of the modular alternating hybrid control system that the present invention describes.

### (3) Collective Nanorobotic 4D Modeling System

The present system's ability to develop modeling simulations in four dimensions is critical to extending intelligence to the nanoscale. Because of the resource constraints, and the consequent communication lags, the high probability of intermittent communications in noisy environments provides a limited picture of CNR events at any given time. The use of modeling simulations overcomes these constraints.

To understand the problem, consider the use of radar or sonar. The sonar will track an entity by bouncing sound waves off of objects within a media. While there are lags in the detection of objects, these are modulated by the cycle of the sound waves as these are recorded on a monitoring device. In the case of the CNRs, intermittent episodes of radio silence occur in which their precise locations are not known. While their general positions and trajectories are known, the communication lags present a dilemma of recording their precise positions in real time.

The use of modeling systems helps to moderate these information constraints regarding the precise positions of the mobile nanorobots. Each nanorobot has a tag or signal that tracks its location relative to the collective. The nanorobots' sensors provide data about their positions and their immediate environments to the computation systems (individual, distributed and external). The modeling process is generally performed by the external computer system, but information about the model is also supplied to the distributed computer network comprised of collectives of autonomous nanorobots. The modeling system maps, tracks and controls the behaviors of multiple CNR teams simultaneously.

Model simulations are generated about the spatial locations of the nanorobots at specific phases of time. The nanorobots' movements are tracked by the sensors, by transmitting signals or by external tracking mechanisms (sonar, radar or x-rays). The models develop a list of trajectories based on the most recent available information and a general map of the CNRs' strategies. As the latest information becomes known, the models are updated in order to update the simulations. Scenarios of possible trajectories are constructed by the models in order to estimate the projected tracks of the nanorobots. These estimations are used to not only track the latest data on the nanorobots locations and to project the probable trajectory for the next phase, but also to issue orders so as to seek course corrections in order to reorient the behaviors of the nanorobots. In order to provide these feedback and control mechanisms, software agents are activated to mimic collective behaviors and then transmit signals to transform the organizational positions of their behaviors. Original strategies and goals are updated as the system learns from its environment. These modeling simulations provide near real time control mechanisms for interaction of the CNRs with their environment. This dynamic process of applied modeling is completely novel, yet highly useful to the successful functioning of a self-organizing system.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

### DESCRIPTION OF THE DRAWINGS

FIG. 1 is a schematic diagram showing the CNR system with connection to a modeling system.

FIG. 2 is a flow chart describing the operation of humoral immunocomputing.

FIG. 3 is a flow chart describing the operation of adaptive immunocomputing.

FIG. 4 is a diagram showing trajectory options of immunocomputing.

FIG. 5 is a flow chart showing the operation of anticipatory immunocomputing.

FIG. 6 is a flow chart showing the operation of a hybrid immunocomputing model.

FIG. 7 is a diagram of an adaptive immunocomputing solution.

FIG. 8 is a flow chart showing the modeling process using immunocomputing simulations to apply to collectives of nanorobots.

FIG. 9 is a flow chart showing the modeling process as it is applied to CNRs.

FIG. 10 is a schematic diagram of the modeling system for CNR interactions with its environment.

FIG. 11 is a schematic diagram of the interactive process that occurs in modeling the CNR as it interacts with its environment.

FIG. 12 is a diagram that shows the detection of CNR mobility by an external system.

### DETAILED DESCRIPTION OF THE DRAWINGS

Immunocomputing provides models for organizing solutions to optimization problems with applications to the operation and self-organization of collectives of nanorobots. Immunocomputing processes are organized according to the two main subsystems of the human immune system (HIS): the humoral and adaptive immune systems. The present system also includes a third immunocomputing model, viz., the anticipatory immune system, which models new and probable problems and seeks to build solutions through simulations. A fourth artificial immune system (AIS) combines the three immune system types to create a hybrid model that integrates the humoral, the adaptive and the anticipatory immune systems.

Immunocomputing is applied to organizing the behaviors of collectives of nanorobots (CNRs) as they interact with their environment in order to provide models for solving complex problems. In the case of CNRs, an interaction process occurs with their environment in which they receive feedback in real time. The CNRs constantly reconfigure their extensible spatial configurations to reassemble according to strategic objectives and continuous environmental feedback.

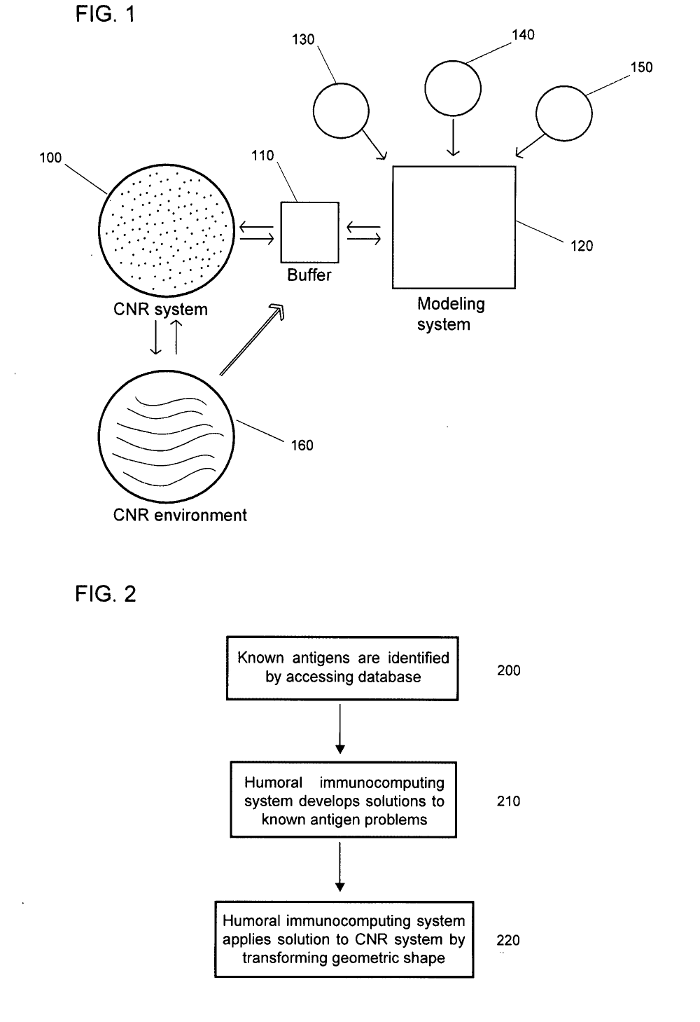

FIG. 1 shows the nanorobotic system (100) as it interacts with the environment (160) and with the modeling system (120). The CNR system interacts with the modeling system by way of a buffer (110) because of communication constraints in the CNR environment. The modeling system uses simulations (130, 140 and 150) to simulate specific processes simultaneously. Data is sent from the CNRs to the modeling system where it is analyzed. Program instructions are then sent back to the CNRs for adjustment of their behaviors.

FIG. 2 shows the operation of the humoral immune system. After known antigens are identified by accessing a database (200), the humoral immunocomputing system develops solutions to known antigen problems (210). The humoral immunocomputing system then applies the solution to the CNR system, which then transforms its aggregate geometrical configuration.

The humoral immune system is a model of learning from the experience of solving problems from the adaptive immune system. Once the adaptive immune system has identified a new problem and proceeds to solve it, it passes the solution on to the humoral system so that when the same problem is identified again it is rapidly solved. This is performed by the adaptive immune system by loading into a database a library of data on solutions to past problems. The humoral immune system accesses the existing solution to old problems that are discovered and then rapidly solved.

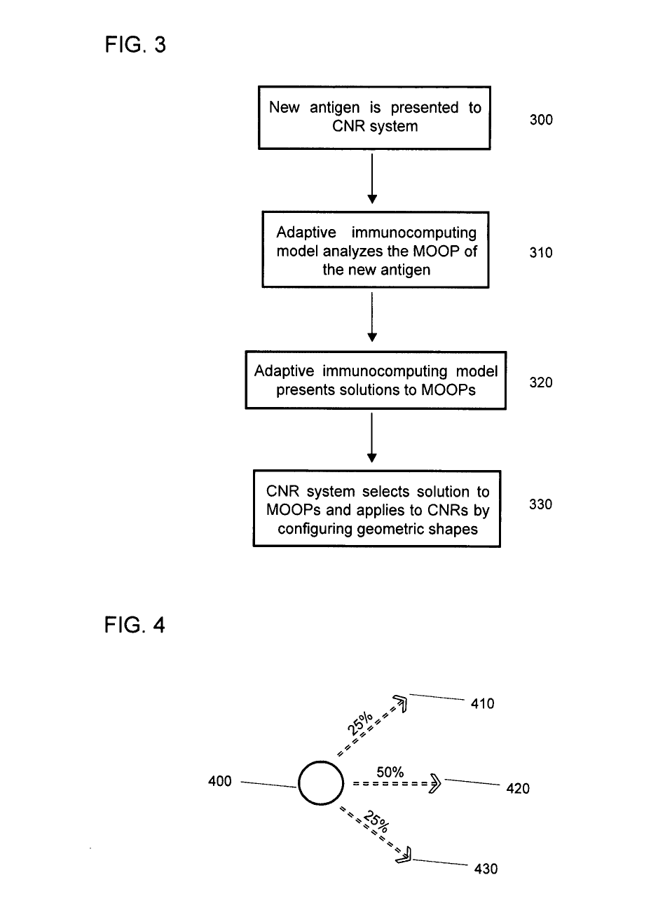

FIG. 3 shows how the problem presented by a new antigen is solved by the adaptive immune system. After a new antigen is presented to the CNR system (300), the adaptive immunocomputing model analyzes the multi-objective optimization problem (MOOP) of the new antigen (310). The adaptive immune system then presents solutions to the MOOPs by modeling the solutions (320). The CNR system selects the solution to the MOOPs and applies it to CNRs by configuring geometric shapes.

FIG. 4 shows the stochastic trajectory options of solutions. There is a fifty percent chance of solution (420) by focusing on a central approach, a twenty five percent chance (410) by pursuing another approach and a twenty five percent chance by pursuing a third approach (430).

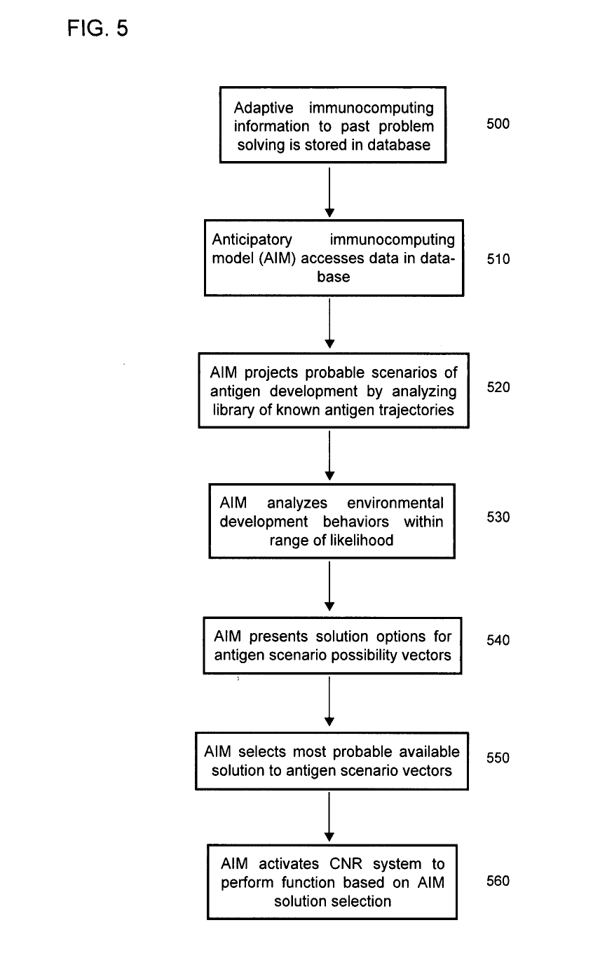

FIG. 5 describes the operation of the anticipatory immune system as it solves optimization problems and is applied to CNRs. First, adaptive immunocomputing information to past problem solving is stored in a database (500). The anticipatory immunocomputing model (AIM) accesses data in the database (510) and the AIM projects probable scenarios of antigen development by analyzing the library of known antigen trajectories (520). The AIM analyzes the environmental development behaviors within a range of likelihood (530) and presents solution options for antigen scenario possibility vectors (540). The AIM then selects the most probable available solution to the antigen scenario vectors (550) and activates the CNR system to perform a function based on the AIM solution selection (560).

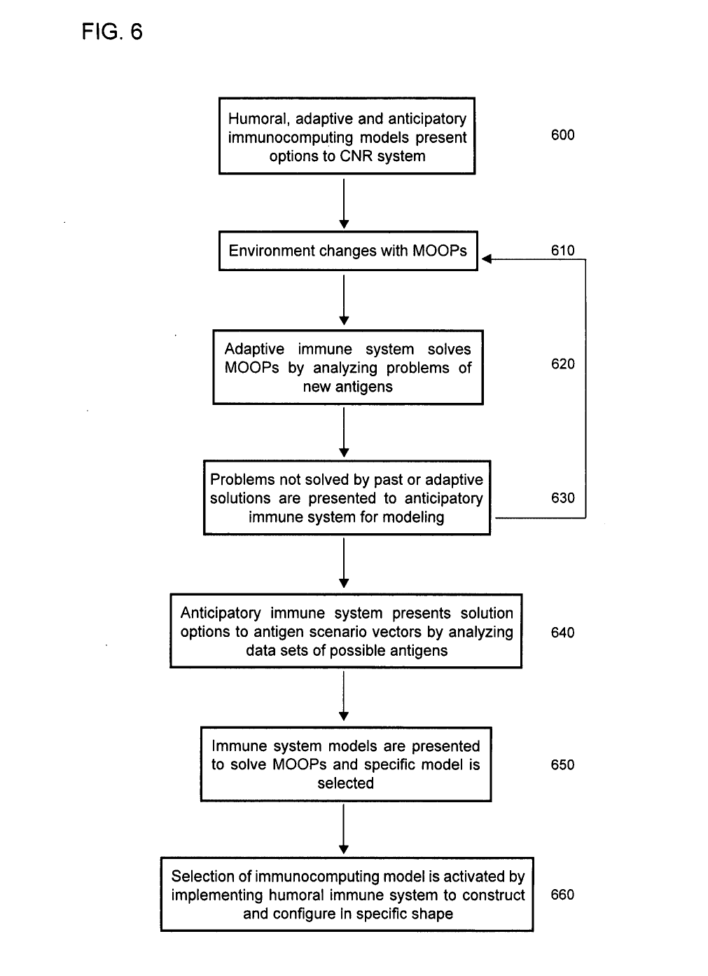

In FIG. 6 the humoral, adaptive and anticipatory immune subsystems are integrated into a hybrid immunocomputing model. Once the three immune subsystem models present options to the CNR system (600), the environment changes with MOOPs (610). The adaptive immune system solves MOOPs by analyzing problems of new antigens (620) and the problems not solved by past or adaptive solutions are presented to the anticipatory immune system for modeling (630). Again, the environment changes and a feedback loop is generated making the MOOPs evolutionary. The anticipatory immune system presents solution options to antigen scenario vectors by analyzing data sets of possible antigens (640). The immune system models are presented to solve MOOPs and a specific model is selected (650). The selection of immunocomputing model is activated by implementing the humoral immune system to construct the CNR into a specific configuration.

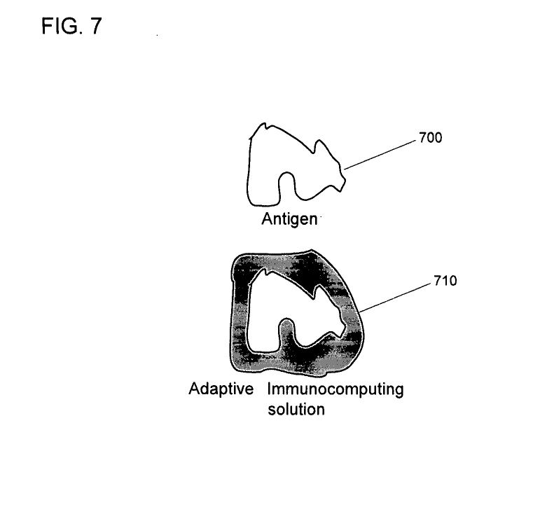

FIG. 7 shows the antigen (700) and the adaptive immunocomputing solution (710) which requires a process of simulating the antigen and solving the novel problem by presenting a new solution.

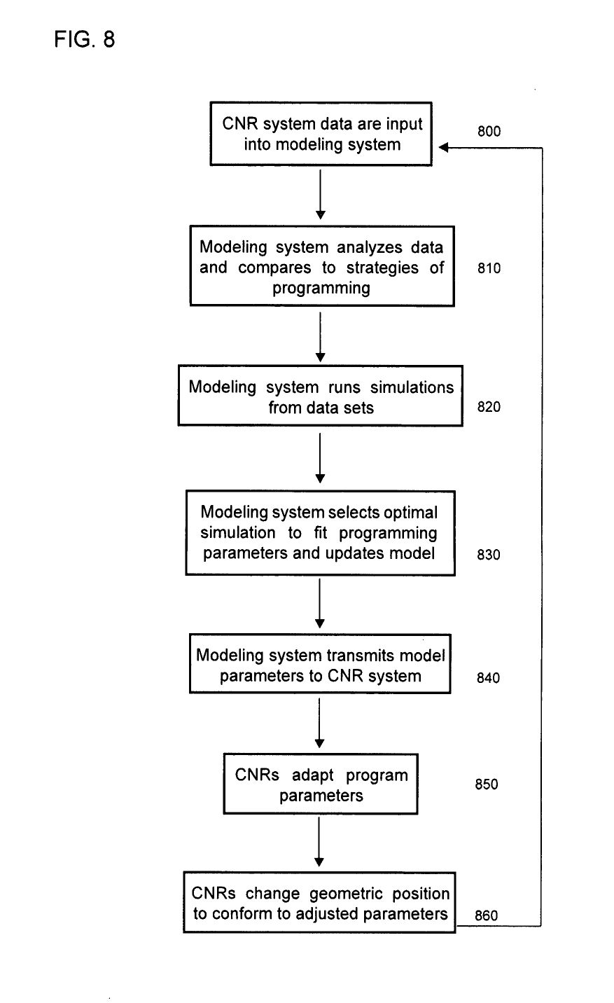

FIG. 8 shows how the modeling system generates and applies solutions to problems involving CNR behaviors. After the CNR system data are input into the modeling system (800), the modeling system analyzes data and compares to strategies of programming (810). The modeling system runs simulations from data sets (820)and then selects an optimal simulation to fit programming parameters and updates the model (830). The modeling system transmits the model parameters to the CNR system (840) and the CNRs adapt their program parameters (850). The CNRs then change geometric position to conform to the adjusted parameters (860). The system then engages in a feedback loop in which new data are input into the model and the sequence repeats.

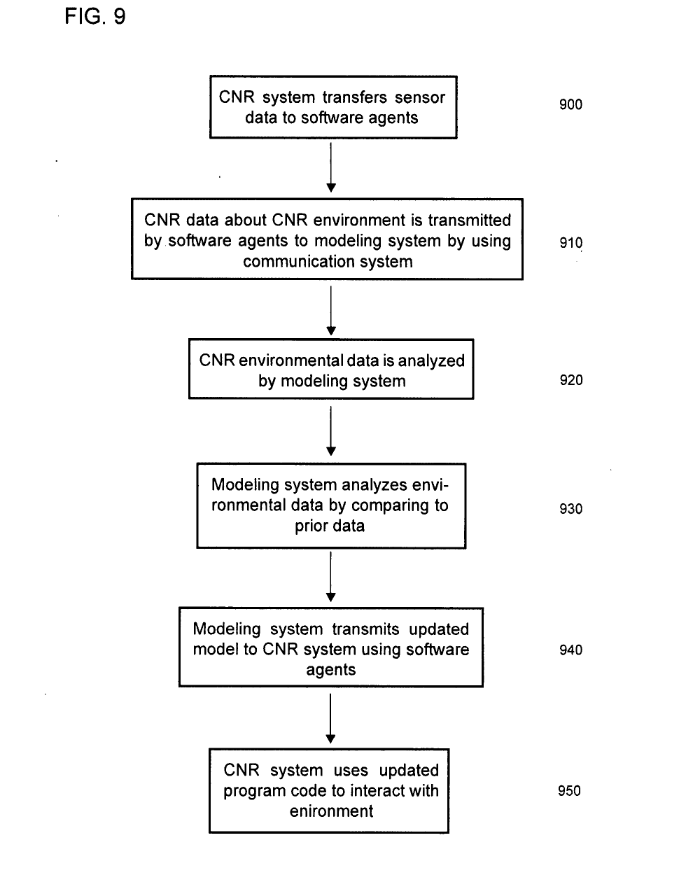

FIG. 9 shows how the system uses software agents. After the CNR system transfers sensor data to software agents (900), the CNR data about the CNR environment is transmitted by software agents to the modeling system by using the communication system (910). The CNR data about environmental interaction is then analyzed by the modeling system (920) and the modeling system analyzes the environmental data by comparing the most recent data to prior data sets (930). The modeling system transmits the updated model to the CNR system using software agents (940). This may be done by using a continuous stream of communication or by using reduced instruction AI program code that efficiently targets specific procedures. The CNR system then uses the updated program code to interact with the environment (950).

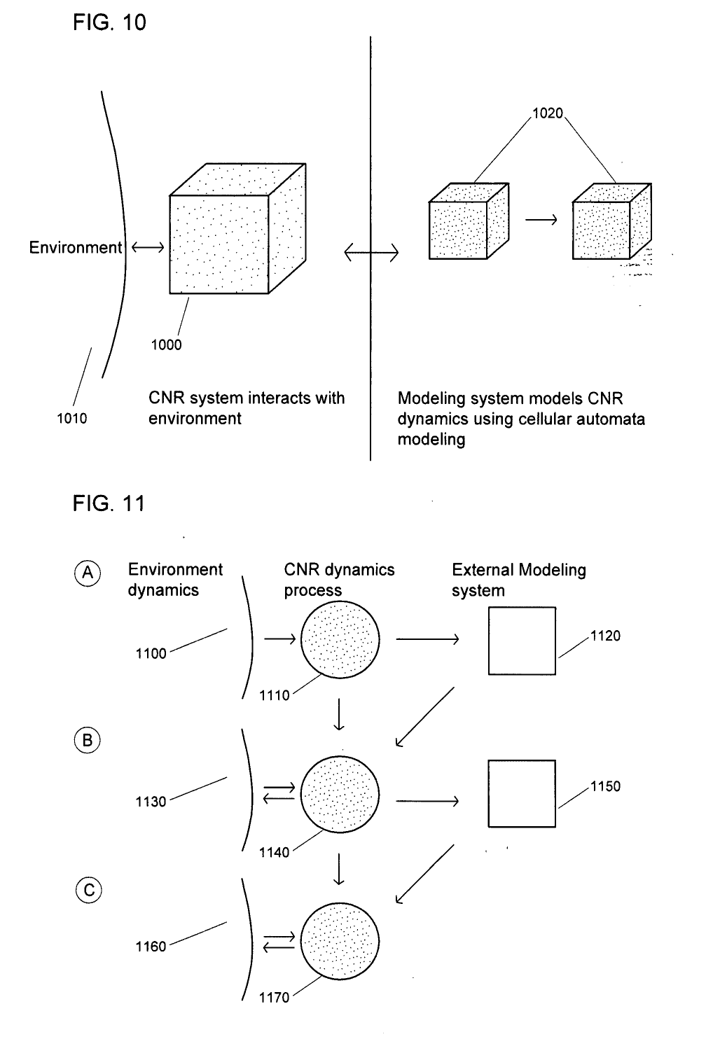

FIG. 10 shows the interaction processes between the CNR system (1000) and its environment (1010) and between the CNR system and its modeling system (1020). The external modeling may use cellular automata modeling processes to model the CNR dynamics that resemble a three dimensional radar system depicting multiple interacting full motion objects. However, the dynamic feedback provided by both the environment as the CNRs interact with it and the modeling system suggest a complex system for controlling social intelligence.

FIG. 11 shows three phases of the environmental interaction of the CNR system as it uses an external modeling system. The environment (1100) provides feedback to the CNR system (1110), which is then modeled (1120) in phase A. In phase B, the CNRs (1140) engage in a dynamic interactive process with the environment (1130) and draw on the modeling of phase A, but the result of the dynamic interaction is production of a new model (1150). The new model then provides inputs to the CNR at phase three (1170) as it interacts with its environment (1160). This process continues until the CNR solves problems or completes its mission.

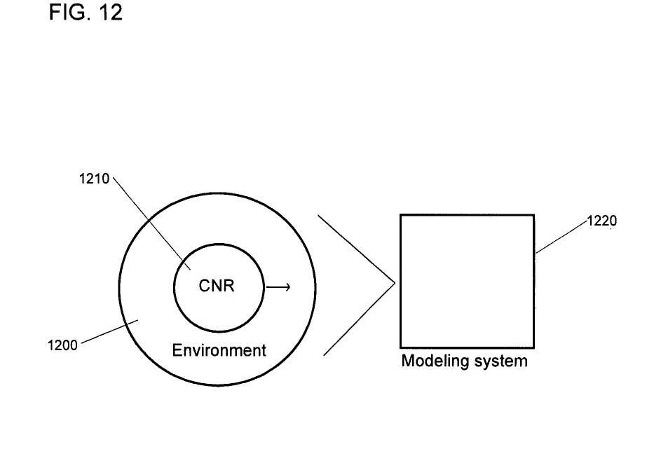

FIG. 12 shows the detection of CNR mobility by a modeling system. The external computer system requires information on the CNR's changing positions as the CNR (1210) interacts within its environment (1200). The modeling system uses external detection approaches, such as X-rays, which are similar to radar, to continuously track the CNR locations as they change positions in real time. This data is supplied to the external modeling system so that the problems are solved and solutions transmitted to the CNR in order for it to adapt its behavior and continuously self-organize to meet mission objectives.

What is claimed is:

1. A system for anticipatory immunocomputing, comprising:
a computer system, including memory, for processing data;
a database management system;
an intelligent mobile software agent (IMSA) system for accessing a database and exchanging data;
wherein the computer system develops computer models to simulate the trajectories of the evolution of artificial antigens;
wherein the computer modeling develops calculations of the rate of change of the mutations of the antigens' evolutionary vectors;
wherein the computer modeling anticipates the evolutionary vector scenarios of the artificial antigens;
wherein data about the immunocomputing anticipatory model is forwarded to a collective of nanorobots (CNR) system using IMSAs; and
wherein the CNR develops specific behaviors to self-organize.

2. A system for hybrid immunocomputing, comprising:
A computer system, including memory, for processing data;
A database management system;
An intelligent mobile software agent (IMSA) system for accessing a database and exchanging data;
Wherein the computer system develops humoral immune system models to apply existing solutions of optimization problems;
Wherein the computer system develops adaptive immune system models to develop solutions for novel combinatorial optimization problems;
Wherein the computer system develops computer models to anticipate the evolution of artificial antigens to solve optimization problems;
Wherein the humoral, adaptive and anticipatory immune system models are integrated into a hybrid immunocomputing model to provide solutions to and apply solutions involving optimization problems;
Wherein a new artificial antigen presents an optimization problem;
Wherein the hybrid immunocomputing model is forwarded to a collective of nanorobots (CNRs) by using IMSAs; and
Wherein the CNR performs specific self-organizing behaviors by adapting its configuration to implement a solution to an optimization problem.

3. A system for managing a distributed computer network, comprising;
A computer system, including memory, for processing data;
A database management system;
An intelligent mobile software agent (IMSA) system for accessing a database and exchanging data;
A collective of nanorobotics with computational capabilities;
Wherein the computer system develops a model of the CNR system;
Wherein the computer model uses three dimensional cellular automata simulations to model the CNR;
Wherein the computer system develop a model of the indeterministic CNR environment;
Wherein the CNR system is comprised of a distributed computer network;
Wherein computer models of the environment are integrated into a model of the CNR system;
Wherein as the environment changes the computer model modeling the environment changes;
Wherein the computer models are sent to the CNR by IMSAs;
Wherein the CNR receives the data on the computer models and changes its geometric configuration;
Wherein the CNR changes its geometric configuration in response to the changes in the environment; and
Wherein the computer modeling is used to make course corrections of the CNRs as the environment changes and as the strategic objectives change.
